(19) United States
(12) Patent Application Publication
(10) Pub. No.: US 2002/0039067 A1
(43) Pub. Date: Apr. 4, 2002

(54) Personnel location system

(76) Inventor: Timothy Eubanks, N. Longbeach, CA (US)

Correspondence Address: Matthew J. Peirce, Esq., 1550 Starlight Canyon Avenue, Las Vegas, NV, 89123, US

(21) Appl. No.: 09/904,136

(22) Filed: Jul. 13, 2001

Related U.S. Application Data
(60) Provisional application No. 60/237,127, filed on Oct. 3, 2000.

(51) Int. Cl. G08B 23/00

(52) U.S. Cl. 340/573.1; 340/539

(57) ABSTRACT

A new and improved apparatus is disclosed that would help users track a missing or lost child. In addition, the apparatus would also help a user located missing or taken individuals in case of cracking, kidnapping, and other missing persons type of cases. The apparatus would preferably be located in a user's watch, but could also be located in a belt, bracelet, pendent, earring, or other article of clothing or item of jewelry.

### I. BACKGROUND OF THE INVENTION

The present invention is that of a new and improved apparatus that would help users track a missing or lost child.

### II. DESCRIPTION OF THE PRIOR ART

U.S. Pat. No. D388,720, issued to Montgomery, discloses an ornamental design for a combined transmitter and receiver for locating lost individuals.

U.S. Pat. No. 5,652,570, issued to Lepkofker, discloses an interactive individual location and monitoring system which includes a central monitoring system for maintain health, location, and other data with respect to an individual.

U.S. Pat. No. 5,014,040, issued to Weaver et al., discloses a personal locator transmitter adapted to be worn on the wrist and having the size and appearance of a conventional wrist-watch.

### III. SUMMARY OF THE INVENTION

The present invention is that of a new and improved apparatus that would help users track a missing or lost child. In addition, the apparatus would also help a user of the apparatus be located in case of carjacking, kidnapping, and other missing persons type of cases. The apparatus would preferably be located in a user's watch, but could also be located in a belt, bracelet, pendent, earring, or other article of clothing or item of jewelry.

There has thus been outlined, rather broadly, the more important features of an apparatus for tracking a missing or lost child in order that the detailed description thereof that follows may be better understood and in order that the present contribution to the art may be better appreciated. There are, of course, additional features of the apparatus for tracking a missing or lost child that will be described hereinafter and which will form the subject matter of the claims appended hereto.

In this respect, before explaining at least one embodiment of the apparatus for tracking a missing or lost child in detail, it is to be understood that the apparatus for tracking a missing or lost child is not limited in its application to the details of construction and to the arrangements of the components set forth in the following description or illustrated in the drawings. The apparatus for tracking a missing or lost child is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present apparatus for tracking a missing or lost child. It is important, therefore, that the claims be regarded as including such equivalent constructions insofar as they do not depart from the spirit and scope of the present invention.

It is therefore an object of the present invention to provide an apparatus for tracking a missing or lost child which has all of the advantages of the prior art and none of the disadvantages.

It is another object of the present invention to provide an for tracking a missing or lost child which may be easily and efficiently manufactured and marketed.

It is another object of the present invention to provide an apparatus for tracking a missing or lost child which is of durable and reliable construction.

It is yet another object of the present invention to provide an apparatus for tracking a missing or lost child which is economically affordable and available for relevant purchasing government entities.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a front view of the present invention in use in a watch.

FIG. 2 shows a perspective view of a radio receiver used with the present invention.

### V. DESCRIPTION OF THE PREFERRED EMBODIMENT

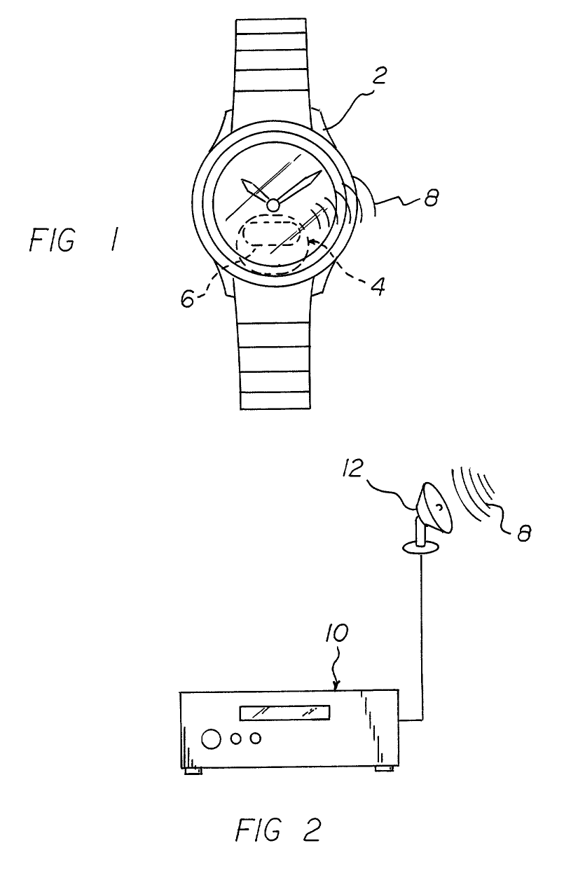

FIG. 1 shows a front view of the present invention in use in a watch 2. The present invention is that of a new and improved apparatus 4 that would help users track a missing or lost child. In addition, the apparatus 4 would also help a user of the apparatus 4 be located in case of carjacking, kidnapping, and other missing persons type of cases. The apparatus 4 would preferably be located in a user's watch 2, but could also be located in a belt, bracelet, pendent, earring, or other article of clothing or item of jewelry.

Apparatus 4 would comprise a radio wave transmitter 6 which would transmit radio waves 8 at a specific frequency. The radio waves 8 could be either transmitted to a radio wave receiver 10 via ground antennae 12 or through the use of the global positioning system (GPS), which would relay the radio waves 8 through a system of satellites to determine precise location. Based on the current technology available, the use of the GPS system might prove to be the most reliable, and soon, more economical, as the cost of GPS systems are rapidly decreasing as the technology gains popularity.

FIG. 2 shows a perspective view of a radio wave receiver 10 used with the present invention. Radio wave receiver 10 is depicted being used by a police department, but in reality, radio receiver 10 could be used by any one of a wide variety of organizations and could be placed in any one of a wide variety of locations. Radio receiver 10 would be designed to pick up frequencies of various radio wave transmitters 6 that would be located on an apparatus that would be attached to a user. Through radio wave receiver 10, a user would be able to properly locate the location of the radio wave transmitter 6, which would be located either on watch 2 attached to the missing person or other item being worn by the missing person.

What I claim as my invention is:

1. An apparatus for helping users track a missing or lost child comprising:
(a) a radio wave transmitter capable of transmitting radio waves at a specific predetermined frequency, the radio wave transmitter being located on an object attached to a child,
(b) a radio wave receiver designed to pick up the radio waves emitted from the radio wave transmitter, the radio wave receiver capable of determining location of the radio wave transmitter, and
(c) a mechanism for direct, routing, and amplifying the radio waves as they travel from the radio wave transmitter to the radio wave receiver.

2. An apparatus for helping users track a missing or lost child according to claim 1 wherein the radio wave transmitter would be attached to a wrist watch.

3. An apparatus for helping users track a missing or lost child according to claim 1 wherein the radio wave transmitter would be attached to an item of clothing.

4. An apparatus for helping users track a missing or lost child according to claim 3 wherein the radio wave transmitter would be attached to a belt.

5. An apparatus for helping users track a missing or lost child according to claim 1 wherein the radio wave transmitter would be attached to a piece of jewelry.

6. An apparatus for helping users track a missing or lost child according to claim 5 wherein the radio wave transmitter would be attached to a pendent.

7. An apparatus for helping users track a missing or lost child according to claim 5 wherein the radio wave transmitter would be attached to an earring.

8. An apparatus for helping users track a missing or lost child according to claim 1 wherein the mechanism for direct, routing, and amplifying the radio waves as they travel from the radio wave transmitter to the radio wave receiver includes the use of at least one ground-based antennae.

9. An apparatus for helping users track a missing or lost child according to claim 1 wherein the mechanism for direct, routing, and amplifying the radio waves as they travel from the radio wave transmitter to the radio wave receiver includes the use of the global positioning system.
